(19) United States
(12) Patent Application Publication
(10) Pub. No.: US 2004/0106381 A1
(43) Pub. Date: Jun. 3, 2004

(54) Transmit signal cancellation in wireless receivers

(75) Inventor: Sam Tiller, Ottawa (CA)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Engim Incorporated, Acton, MA

(21) Appl. No.: 10/655,748

(22) Filed: Sep. 5, 2003

Related U.S. Application Data
(60) Provisional application No. 60/409,096, filed on Sep. 6, 2002.

(51) Int. Cl. H04B 1/38; H04B 17/02

(52) U.S. Cl. 455/73; 455/136

(57) ABSTRACT

An interference canceling method and apparatus reduces the level of signal impinging on a wireless receiver due to the transmitted signal from the same transceiver. A signal sampler, such as directional coupler samples a portion of the transmitted signal. The gain and phase of the sampled signal are adjusted to create an equi-amplitude signal that is 180 degrees out of phase with the unwanted coupled transmit signal. The combination of the gain-phase adjusted signal with the received signal effectively cancels the unwanted transmit signal. Once configured, the interference canceller can continue to operate without further adjustment. Adjustments can be made periodically, however, when necessary to accommodate for changes such as environmental changes.

### RELATED APPLICATION

This application claims the benefit of U.S. Provisional Application No. 60/409,096, filed Sep. 6, 2002. The entire teachings of the above application are incorporated herein by reference.

### BACKGROUND OF THE INVENTION

In wireless communications systems, transmitters are generally designed to transmit at high power levels to maximize operational range; whereas, receivers are generally designed to receive signals at low power levels. This wide variation in power levels poses a design challenge for any bi-directional wireless system including both a transmitter and a receiver, because it can lead to noise at the receiver due to undesirable direct coupling from the transmitter to the receiver.

Generally, the greater the distance between a transmitter and a receiver the greater the isolation due to free space propagation loss. Isolation is a measure of the coupling between a transmitter and a receiver. A greater value of isolation, generally results in less coupling and is preferred. In a bi-directional system, the transmitter and receiver are by design relatively close together. The close proximity of the transmitter and the receiver tends to limit the amount of achievable isolation. A schematic block diagram of a transceiver 100 is shown in FIG. 1. The transceiver 100 includes a transmitter 102 receiving a baseband signal at a baseband input 104. A frequency up-converter 106 translates, or otherwise up-converts the baseband signal to a radio frequency (RF) signal. A high-power amplifier 110 receives the RF transmit signal from the up converter 106 and amplifies it to a transmit power level. The high-power transmit signal is output from the transmitter 102 at an RF output port 112. Generally, the high-power transmit signal is coupled to a transmit antenna 140 through a transmit path 135. The transmit path can include, for example, a transmission line, connectors, and possibly filters. Ultimately, the high-power transmit signal, less the effects of the transmit path 135 is transmitted from the transmit antenna 140.

The transceiver 100 also includes a receiver 120 that receives an RF signal at an RF input 122. The RF signal is first received at a receive antenna 150. As with the transmit signal, the antenna 150 is coupled to the RF input 122 through a receive path 145. The receive path 145 can also include, for example, a transmission line, connectors, and possibly filters.

A receiver 120 typically includes an amplifier, such as a low-noise amplifier 124 that receives the RF signal from the RF input 122. The low-noise amplifier 124 enhances low power performance of the receiver 120 by amplifying low-level received signals. (The low-noise characteristics of the amplifier 124 preserve the received signal to noise ratio by limiting its contributing to the noise floor.) A frequency down-converter 126 next receives the amplified received signal and translates it, or otherwise down-converts it from RF to baseband.

Also shown are multiple possible coupling paths from the transmit signal to the receiver. First, an antenna-to-antenna coupling (α_{ANT}) path represents a measure of the coupling or limited isolation between the transmit and the receive antennas. Similarly, a component-to-component coupling (α_{comp}) is shown represents a measure of the isolation between the transmit path 135 and the receive path 145. Further, as the transmitter 102 and receiver 120 may be located on separate, but nearby modules or printed circuit boards, a circuit board-to-circuit board coupling (α_{PCB}) is shown represents a measure of the isolation between the transmitter 102 and the receiver 120. Still further, in applications in which both the transmitter 102 and the receiver 120 are located on the same integrated circuit, an on-chip coupling (α_{IC}) represents a measure of the isolation between the transmitter 102 and receiver 120. Each of the coupling paths represents a separate mechanism for introducing unwanted noise into the receiver 120. That is, a portion of the transmit signal can couple into the receiver 120 at any one or more of the identified coupling paths α_{ANT}, α_{COMP}, α_{PCB}, α_{IC}.

In some applications, such as single channel wireless LAN transceivers using one of the 802.11 protocols, the requirement for isolation from transmitter output to receiver input can be mitigated by using a time division duplex technique (i.e., at any instant of time the signal is either transmitted or received, but not both). Time division duplexing can be useful in single-channel systems; however, this technique loses its effectiveness in multi-channel transceivers in which time division duplex is applied to individual channels, but not across multiple channels (i.e., transmit on one channel interfering with receiving on another channel). Namely, the individual channels in a multi-channel 802.11 transceiver can be time division duplexed, but there is no guarantee that the scheduling of transmit and receive times for different channels are similarly synchronized. Thus, for applications in which time division duplex is not used or cannot be guaranteed across different channels, the large signals radiated by a transceiver's own transmitter can severely compromise a receiver's functionality.

Generally, high power signals can introduce non-linearities, such as harmonics and/or intermodulation distortion in a receiver that tend to distort, or mask a typically smaller received signal. Further, broadband signals, such as those used in a multi-channel 802.11 wireless local area network (LAN) can introduce an additional detrimental impact to the local receiver 120. Due to the broad-band nature of the 802.11 transmit signal, it may not be completely confined within a single channel. In particular, the modulated signal includes sidebands that occupy a range of frequencies. At the high signal power levels near the transmitter 102, significant energy from a transmitter operating at one channel may reside within adjacent channels being used by the local receiver 120. This energy present in adjacent channels can also mask desired receiver signals in these adjacent bands.

For at least these reasons, it is desirable to remove the transmit signal and its artifacts from the receiver. Several techniques are well known in the art for reducing the level of transmit signal appearing at the receiver.

One such technique is referred to as frequency division duplexing whereby transmitter and receiver signals occupy different frequency ranges. Frequency selective filters can then be used to pass only the receiver signal, and reject the transmitter signal to isolate the receiver from the transmitted signal. Such receiver filters are typically placed as early in the receive chain as possible (i.e., closer to the receive antenna 150 and before the low noise amplifier 124). These filters usually operate at radio frequencies (RF) removing unwanted coupling from the transmitter 102 to protect the low-noise amplifier 124 and to alleviate receiver linearity issues. Operation at RF, however, tends to place severe restrictions on the filter's attenuation response. This is particularly challenging when the transmit and receive bands are closely spaced (e.g., separated by less than 1% of the center frequency). Further, if the frequency separation between transmitted and received signals is small, a filtering approach alone may not reduce transmitted energy residing in adjacent channels as described above. Still further, receivers would be more complex as separate filters would be required for each receiver channel.

Yet another approach uses a high quality factor notch filter placed before the receiver to attenuate the transmitted signal. The high quality factor filter is used to attenuate, or notch out the unwanted transmit signal, while preserving the intended received signal. Due to the high quality factor of the notch filter, it is sensitive to environmental changes and typically requires continuous adjustment. Also, integrated circuit implementations of a tunable notch filter would generally contribute too much noise to be used as the first component in a receiver. Thus, any integrated-circuit implementation would necessarily be preceded by one or more gain stages, placing additional linearity constraints on these preceding stages. As with frequency duplexing, this approach is of limited benefit when the transmitter and receiver signals have small frequency separation. Finally, if more than one transmit channel are active, multiple receive notch filters would be required.

### SUMMARY OF THE INVENTION

The invention described herein alleviates both the linearity and transmitter out of band energy concerns of the previous approaches. Rather than attenuating or filtering the unwanted energy, a sample of the interference is obtained and manipulated to create a duplicate of the interfering transmit signal with a 180 degree phase relationship between the same. When the manipulated, anti-phase duplicate of the interfering transmit signal is combined, or vector summed with the received signal including the interference, the interfering transmit signal is cancelled. The remaining received signal is largely unaffected by the signal combination and represents the received signal, less the interference.

A wireless network transceiver system reduces interference at a local receiver by reducing unintentional coupling of a local transmit signal to the local receiver. The system includes an RF transceiver having a transmit path and a receive path. The system also includes a sampler obtaining a sample of a transmit signal from the RF transmit path. A gain-phase adjuster circuit adjusts the transmit signal sample and supplies it to the receive path. The system also includes a gain-phase controller that adjusts the gain-phase adjuster circuit to minimize the effects of the transmit signal cross coupling into the receive path.

In some embodiments, the gain-phase adjuster circuit includes a controllable phase shifter. The controllable phase shifter receives the sampled transmit signal and shifts the phase of that signal in response to adjusting the gain-phase adjuster circuit. A controllable amplitude adjusting device can be coupled to the controllable phase shifter for adjusting the amplitude of the phase shifted transmit signal sample in response to adjusting the gain-phase adjuster circuit.

For example, the controllable phase shifter can include a poly-phase filter generating from the transmit signal sample a pair of signals having relative phases that are substantially orthogonal with respect to each other. A vector modulator can also be coupled to the poly-phase filter for adjusting the amplitude of at least one of the signal pair in response to adjusting the gain-phase adjuster circuit. The adjusted pair of signals are then recombined to yield a phase-adjusted signal.

The controllable amplitude adjusting device can include a variable attenuator that varies the amplitude of the phase-adjusted signal in response to adjusting the gain-phase adjuster circuit. Alternatively, or additionally, the controllable amplitude adjusting device can include a variable gain amplifier, varying the amplitude of the phase-adjusted signal in response to adjusting the gain-phase adjuster circuit. In some embodiments, the gain-phase adjuster circuit also includes a device for converting a single-ended transmit signal sample to a differential transmit signal sample. This device is sometimes referred to as a balanced-to-unbalanced transformer, or balun.

Still further, the system can include a receive path simulator coupled between the sampler and the gain-phase adjuster circuit. The receive path simulator simulates the effects of the receive path. The system can further include a delay device, such as a length of transmission line, also coupled between the sampler and the gain-phase adjuster circuit. The delay device adds a delay to the transmit signal sample.

In some embodiments a second sampler is coupled at a different location within the transmit chain. Similar to the first sampler, the second sampler can be coupled to a second gain-phase adjuster circuit that also supplies it to the receiver path. The sampler obtains a second transmit signal sample that is related to another transmit-to-receive coupling path. Similarly, the second transmit signal sample is gain-phase adjusted in response to adjusting the second gain-phase adjuster circuit. The combination of the second gain-phase adjusted signal with the intended receive signal, similarly cancels the coupled transmit signal from the other transmit-to-receive coupling path.

A method for canceling receiver interference within a transceiver, resulting from coupling of a local transmit signal at the receiver, includes calibrating gain and phase offsets. A sample of a transmit signal having an amplitude and a phase is coupled. The gain of the coupled sample transmit signal is adjusted using the gain offset. Similarly, the phase of the coupled signal is adjusted using the phase offset. An intended signal is received and the gain-phase adjusted transmit signal sample is combined with the intended received signal prior to down-conversion and preferably before the input of the first receiver amplifier.

The step of calibrating the gain and phase offsets can include transmitting a known signal from the transmitter and tuning the receiver to a selected frequency, such as the frequency of the known transmit signal, the frequency of a preferred receive channel, or an average frequency of multiple receive channels. That amount of the transmit calibration signal coupled to the receiver is measured at the receiver's baseband output. The gain and phase offsets of the sampled signal are adjusted in response to the measured receiver's baseband output. Further, the transmitted calibration signal can be a narrowband signal or a broadband signal. For example, the broadband signal can be an 802.11 signal.

A wireless network transceiver system reduces interference at a local receiver by reducing unintentional RF coupling of a local transmit signal to the local receiver. The system includes a controller generating a control input and a sampler sampling a transmit signal having an amplitude and a phase. A gain-phase adjuster circuit is coupled to the controller and the sampler. The gain-phase adjuster circuit receives the transmit signal sample and the control input and adjusts the gain and phase of the transmit signal sample in response to a control input received from a controller. A signal combiner can be coupled between the gain-phase adjuster circuit and the receiver, the combiner creating an adjusted received signal by combining the gain-phase adjusted transmit signal sample with the intended received signal. A controller, such as a baseband controller, can be included to generate adjusting signals to and/or for the gain-phase adjuster circuit in response to receiving a baseband representation of the received signal.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic block diagram of a wireless communication system;

FIG. 2 is a schematic block diagram of an embodiment of an interference cancellation system in a wireless communication system;

FIG. 3 is a schematic circuit diagram of one embodiment of the gain-phase adjuster circuit of FIG. 2;

FIG. 4 is a flow diagram of one embodiment of a calibration procedure for the interference cancellation system of FIG. 2; and

FIG. 5 is a schematic block diagram of an alternative embodiment of an interference cancellation system in a wireless communication system.

### DETAILED DESCRIPTION OF THE INVENTION

A description of preferred embodiments follows.

The interference canceling technique described herein alleviates both the linearity and transmitter out-of-band energy concerns of the previous approaches. Advantageously, the interference is cancelled at the RF signal stage prior to down conversion and preferably between the receiver's first amplifier and the receive antenna. Canceling the interference before any receiver gain stages greatly reduces the linearity requirements of the receiver itself. Further, the interference canceller can be configured once, then continue to operate without further adjustment. Adjustments, however, can be made periodically whenever necessary to accommodate for any changes such as environmental changes. Further, as the interference canceller is configurable, its configuration can be optimized to a desired receive channel or band. For example, the interference canceller can be configured to optimize signal reception at a channel reserved for low-level signals, by canceling the coupled transmit signal within the receiver channel from the transmit signal at another channel.

In general, a standard transceiver architecture can be modified to sample the transmit signal at a particular location within the transceiver, along the transmit path, and/or at the input to the transmit antenna. The amplitude and phase of the sampled signal are then adjusted according to prescribed settings. The adjusted sampled signal can then be combined, or vector summed, with the received signal. As the adjusted sampled signal represents an anti-phase version of the unwanted coupled transmit power, the contributions of the transmitter are cancelled by their combination. Further, as the gain and phase settings are prescribed or stored, the cancellation can continue for a period of time without further adjustment. Periodically, the gain and phase settings can be updated and re-stored.

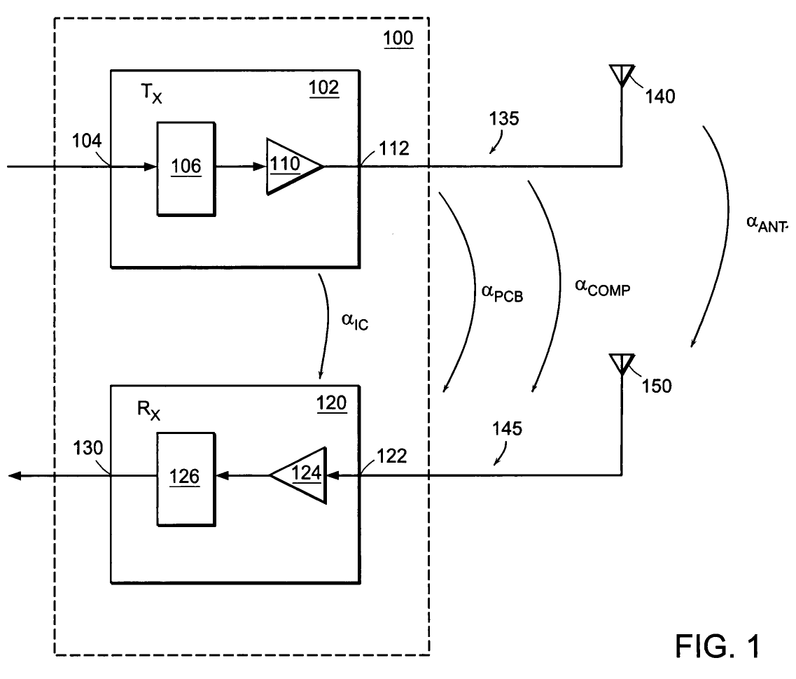

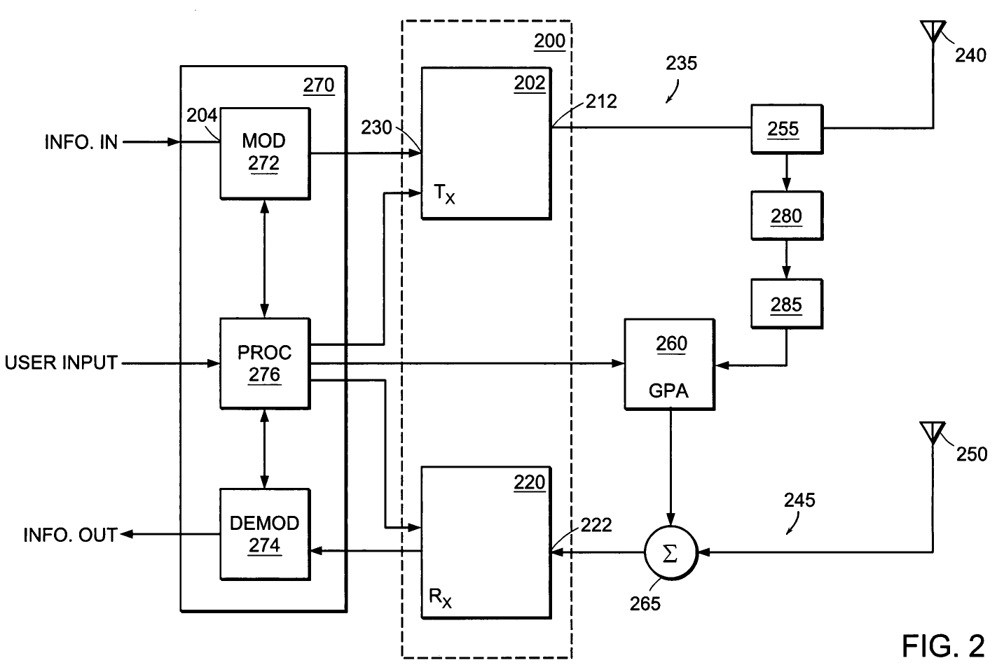

One embodiment of an interference canceling system implemented in a transceiver 200 is shown in FIG. 2. The transceiver 200 includes a transmitter 202 configured to receive a modulated transmit signal at a baseband input 204. The transmitter 202 up-converts the baseband signal to an RF signal and transmits an RF signal at an RF output 212. The transmitter is coupled to a transmit antenna 240 through transmit path 235, as described above in relation to FIG. 1. A receive antenna 250 is similarly coupled through receive path 245 to a RF input 222 of a receiver 220.

A baseband section 270 includes a modulator 272, a demodulator 274, and a baseband processor 276. The baseband section 270 can be included within the transceiver 200 (e.g., within the same chassis, or on the same chip), or can be separate, as shown. The baseband section 270 generally includes an input for receiving from another source information to be transmitted, and an output for forwarding to an external destination information received. Such information can include data, voice, video, and combinations thereof. The modulator 272 receives input data and impresses the information upon a signal, such as an electrical signal, through modulation. The modulated signal is coupled to the baseband input 204 of the transmitter 202. The demodulator 274 receives a baseband representation of the received signal from the baseband output 230 of the receiver 220. The demodulator 274 demodulates the received baseband signal, thereby obtaining any information content impressed thereon. The demodulated signal is coupled from the demodulator 274 to an information output.

The baseband processor 276 can be a digital device and is typically coupled to both the transmitter 202 and the receiver 204, providing control information, such as frequency tuning information. In some embodiments, the baseband processor 276 receives a user input to control the tuning of the transmitter 202 and/or the receiver 220.

As illustrated, the transmitted signal is coupled from the transmit antenna 240 to the receive antenna 250 through the antenna-to-antenna coupling path (α_{ANT}). The transmit signal energy generally appears at the receiver antenna terminals with a related power level of P_{T}−α_{ANT} (the values of power and attenuation being expressed in logarithmic terms, i.e., decibels). To cancel this coupled transmit energy at the receiver 220, the interference canceling system can include a sampler 255 coupled between the transmit path 235 and the transmit antenna 240. The sampler is a three-port device, such as a directional coupler, that selectively couples a sample of the transmitted signal at the input of the transmit antenna 240. The transmit signal sample is further coupled to a gain-phase adjuster circuit 260, that is coupled further to a signal combiner 265. The signal combiner 265 is coupled between the receive path 245 and the receiver 220. The combiner 265 combines the intended received signal (including the unwanted coupled transmit signal) with a gain-phase adjusted signal from the gain-phase adjuster circuit 260.

Notably, the output signal from the Gain-phase adjuster circuit need not be a voltage, or even have the same impedance as the equivalent impedance at the summing node. It is possible to represent the cancellation signal as a current and the output as a high impedance current source. This minimizes the loading on the receiver input and limits the noise figure degradation caused by the cancellation circuitry.

Thus, in some embodiments, the signal combiner 265 is a direct interconnection of the gain-phase adjuster circuit output to the receiver. In a direct interconnection configuration, the gain-phase adjuster circuit output can function as a current injector. That is, the signal combiner 265 represents the gain-phase adjusted signal as a current source. The current source advantageously includes a high output impedance as observed by the input of the receiver's low-noise amplifier. This embodiment alleviates the need for an impedance match, further preserving the broad-band aspects of the interference canceller. Further, the current injection combiner is particularly well suited for integrated circuit implementations. In some embodiments, the combiner can include a vector summing device or a voltage source combiner.

Advantageously, the gain-phase adjuster circuit 260 adjusts the gain and phase of the transmit signal sample to substantially reduce, or otherwise cancel the unwanted coupled transmit signal coupled through the receive antenna 250. In effect, the gain-phase adjuster circuit 260 creates an equi-amplitude, 180 degrees out-of-phase copy of the unwanted coupled transmit signal. The out-of-phase copy is then combined with the received signal including the unwanted transmit signal, thereby canceling the unwanted coupled transmit signal.

There are several possible methods for controlling the gain-phase adjuster circuit 260, none being critical to the cancellation technique. For example, the gain-phase adjuster circuit 260 can be controlled by the baseband processor 276 as shown. Notably, the cancellation is implemented by hardware, such as the sampler 225, the gain-phase adjuster circuit 260, and the signal combiner 265 discussed above. A calibration procedure, discussed in more detail below, is generally used to preset at least some of the hardware, such as the gain-phase adjuster circuit 260.

The result of controlling the gain-phase adjuster circuit 260 using the baseband processor 276 is the cancellation of the transmitter signal at the summing node output. The output of the combiner 265 contains the intended received signal less the unintended, coupled transmit signal. The interference cancelled signal is coupled from the combiner 265 to the input of the receiver 220 for further amplification, down-conversion, and ultimately detection.

Note that this example shows the canceling of antenna-to-antenna coupling. That a similar approach could be used to cancel transmitter to receiver leakage via other paths is self-evident.

The signal cancellation approach offers several benefits when compared to the approaches noted in the prior art. Firstly, the transmitted signal is cancelled before any of the active circuitry of the receiver. This implies that the receiver can tolerate a higher transmitter-to-receiver coupling without requiring additional linearity and the resulting increase in power consumption. Secondly, the replica of the transmitter signal also contains the appropriately scaled out of band energy. Advantageously, the out-of-band energy of the unwanted coupled transmit signal will be cancelled, making this approach viable for situations in which the transmitter and receiver are very closely spaced in frequency. Thirdly, since the actual transmitted power at the point it is sampled is typically much greater than the transmitted power seen at the receiver, it is possible in some cases for the gain and phase adjustment block to be passive and consume no power from the circuit supplies.

In some embodiments, a receive path simulator 285 is included, coupled between the sampler 255 and the gain-phase adjuster circuit 260. The receive path simulator mimics upon the transmit signal sample, the amplitude effects of the receive path. The result is to establish a sampled signal that closely resembles the coupled interfering signal. In some instances, the receive path simulator 285 is a replica of the actual receive path 245 (i.e., using the same components). The overall result is to improve the bandwidth of the signal cancellation. That is, the receive path may include filters, or other frequency-depended devices. By applying the same frequency-dependent transformations to the transmit signal sample prior to the gain-phase adjustment, the resulting out-of-phase combination will better match the actual coupled transmit signal over a broader bandwidth.

In other embodiments, a delay device 280 is coupled between the sampler 255 and the gain-phase adjuster circuit 260. The delay device 280 equalizes the delay experienced by the cancellation signal and receiver signal, specifically the additional propagation delay from the transmitter antenna to the receiver antenna. The overall result is to again further improve the resulting bandwidth of the signal cancellation. In particular, the external delay can compensate for delay differences between the transmit signal sample and the received interfering signal due to propagation delay in the antenna-to-antenna coupling path. For example, the compensating delay is selected to equate to the antenna-to-antenna propagation delay. Additionally, external delays can compensate for other delays due to the RF receive path, such as lengths of transmission line or other phase-dependent devices. By applying the same phase delay to the transmit signal sample prior to the gain-phase adjustment, the resulting out-of-phase combination will better match the actual coupled transmit signal over a broader bandwidth.

In other embodiments, both the receive path simulator 285 and the delay device 280 are coupled between the sampler 255 and the gain-phase adjuster circuit 260. These additional features ensure that the cancellation signal and the signal from the receiver antenna effectively pass through identical circuitry being subject to the same amplitude and phase variations.

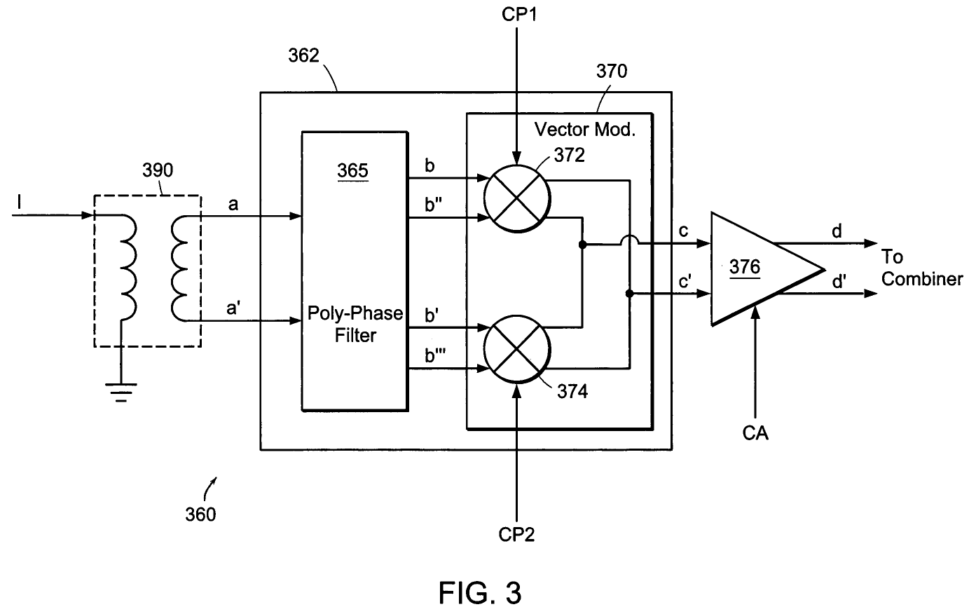

In general, the gain-phase adjuster circuit 260 separately varies the gain and/or the phase of the transmit signal sample in response to control inputs. Notably, a phase adjustment of one cycle (e.g., +/−180 degrees) is generally sufficient, as only a relative phase between the sampled and the interfering signal is required. Should additional delay be necessary, a separate delay block can be added as described in more detail below. Thus, one possible embodiment of the gain-phase adjusting circuit suitable for integrated circuit implementation gain and phase adjustments is shown in FIG. 3.

In differential signal embodiments, the input signal, I, to the gain-phase adjuster circuit 360 is first converted from a single-ended signal to a differential signal using a balun transformer 390. The differential output of the balun 390, shown as a, a′, is coupled to the differential input of a phase shifter 362. In one embodiment, the phase shifter 362 includes a poly-phase filter 365 and a vector modulator 372, 370. Thus, the balun's differential output a, a′ is coupled to a differential input of the poly-phase filter 365. The poly-phase filter 365 generates an orthogonal, or 90-degree offset of the differential input signal. Thus, the outputs of the poly-phase filter 365 include two differential signals, b, b″, and, b′, b′″, each a replica of the original input. More particularly, the phase relationship of these signals is defined by the poly-phase filter 365, such that, relative to signal b, the signal b′ is shifted by 90 degrees, b″ is shifted by 180 degrees, and b′″ is shifted by 270 degrees. Or equivalently, the differential signal b, b″ is shifted by 90 degrees with respect to differential signal b′, b′″.

The outputs of the poly-phase filter 365 are coupled to the vector modulator 370. In more detail, internal to the vector modulator 370, the differential signal b, b″ is multiplied by a first weighted factor CP1, in a first multiplier 372, such that the output of the multiplier 372 is a scaled version of the input. Similarly, the differential signal b′, b′″, which is phase shifted by 90 degrees relative to b, b″ but otherwise identical, is multiplied by a second weighting factor CP2 in a second multiplier 374. The differential outputs of the two multipliers 372, 374 are connected together at the output of the vector modulator 370, shown as c, c′. By varying the weighting factors CP1, CP2 over the range of −1 to +1 (or any symmetric range about 0), the phase of the output at c, c′ can be varied continuously throughout 360 degrees.

In some embodiments, CP1 and CP2 are correlated. For example, by selecting CP1 proportional to cos θ and CP2 proportional to sin θ, where θ is the desired output phase shift, the output signal level at c, c′ can be kept constant.

The outputs of the phase shifter 362 are coupled to the inputs of a variable gain device, such as a variable-gain amplifier 376. In general, the variable gain device scales the input signals c, c′ by a further weighting factor CA such that the output d, d′ is proportional to the input signal c, c′. The signal at d, d′ can then be connected to the signal combiner at the receiver, as shown in FIG. 2.

In some embodiments, the variable gain device can be a variable attenuator, attenuating the phase-shifted signal by a selectable value controlled by the amplitude-weighting factor CA. In other embodiments, the variable gain device can be a variable gain amplifier 376, as described above, similarly controlled by the amplitude-weighting factor CA. In still other embodiments, the variable gain device can be a combination of a fixed and/or variable gain amplifier 376 and a variable attenuator.

It is evident to someone skilled in the art that many permutations of the components inside the Gain-phase adjuster circuit 360 described above, such as, but not limited to, changing the order of the phase shifter 362 and variable gain device 376 will also result in similar functionality. Also, many other embodiments of phase shifters or variable gain devices are possible without altering the basic functionality of the interference canceller.

Advantageously, the interference canceling technique described above can be pre-configured to establish a suitable gain-phase adjustment for a given transceiver. As the coupling paths from the transmitter to the receiver are primarily dependent on the system architecture and the immediately local environment, the coefficients CP1, CP2, and CA, can be determined during a calibration procedure, then stored and used over a period of time. However, the coupling may depend on thermal fluctuations in certain components, such as thermal expansion of transmission lines effecting delays. Additionally, variations in the local environment, such as relocation of office furniture, or the movements of persons around either of the antennas will generally affect the propagation amplitudes and/or delays, and thus, the antenna-to-antenna coupling.

Accordingly, the gain-phase adjuster circuit 360 can be configured and reconfigured during a calibration procedure. The calibration procedure is generally used determine, or update the coefficients CP1, CP2, and CA resulting in an optimal interference cancellation. The coefficients can be stored locally in the gain phase adjuster circuit 360, stored within a memory of the baseband processor, or stored remotely within a memory device accessible by the baseband controller and/or the gain phase adjuster circuit 360. Further, for continued optimal performance, the calibration procedure can be repeated periodically to update the coefficients, thereby accommodating for variations in either the device and/or the environment. The period between calibrations can be variable. For example, the calibration can be performed periodically, such as once every minute, or once every ten minutes. Alternatively, or in addition, the calibration can be performed, for example, after the transmission and or reception of a predetermined number of packets (e.g., after every 1,000, or 10,000 packets).

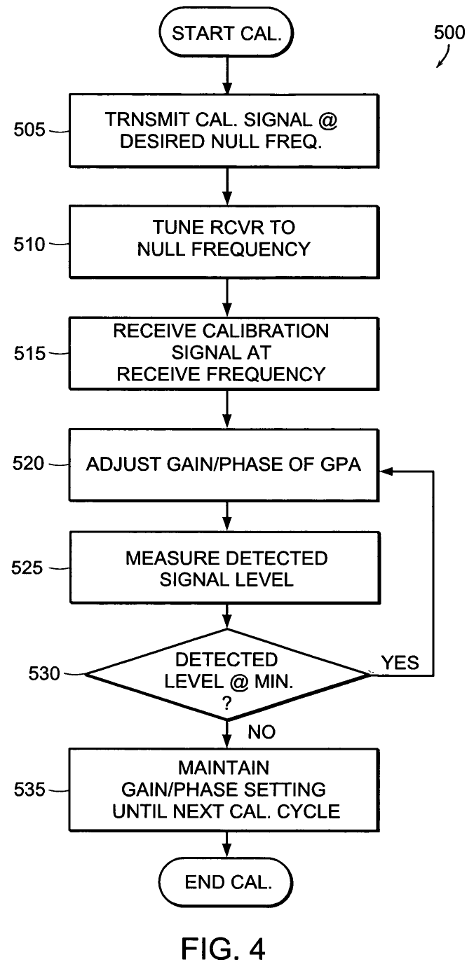

In one embodiment of a calibration procedure identified in FIG. 4, the transmitter transmits a calibration signal at a selected frequency (505). For applications in which the transmitter is under the control of a baseband processor, the baseband processor can direct the initiation of the calibration procedure and select the transmit calibration frequency. Further, the transmit calibration signal may be a pure tone, or a modulated signal, such as an 802.11 modulated signal. Next, the receiver is tuned to a selected receive frequency (515). Like the transmitter, the baseband processor may also select and/or control the receiver tuning.

Generally, during a calibration procedure, the receiver is tuned to the same frequency as the transmit calibration frequency. As the detected energy is minimized through adjustment of the gain-phase adjuster circuitry, as described above, the interference cancellation is optimized at the calibration frequency. That is, interfering signals appearing at the calibration frequency will be maximally cancelled. Although the cancellation is generally broad band, the resulting cancellation does degrade at increasing frequency variations from the calibration frequency.

Often, the calibration frequency is selected to be the operational frequency of the local transmitter. This effectively “nulls” the transmit signal within the receiver. There are some instances, however, when it would be advantageous to optimize the performance of the interference canceller at a frequency other than the operation transmit frequency. For example, some signals contain substantial energy within the sidebands, but relatively little energy at the center signal frequency. Additionally, multichannel operation, such as multi-channel 802.11 operation, may designate certain channels for low signal reception. It is unlikely that a transceiver would transmit on the low power receive channel; nevertheless, performance may be improved if transmitter cancellation is optimized at the low power channel frequency. Still further, in multi-channel operation, optimal receiver performance may be obtained by performing calibration at a frequency other than an operational channel frequency. For example, calibration can be performed at an average frequency occurring between the multiple channels. Advantageously, as interference cancellation provides a tunable calibration transmit signal, the cancellation can be obtained at any selected frequency for optimal performance.

Thus, once the transmit calibration signal is established and the receiver is tuned to the selected frequency, an initial gain and/or phase adjustment is implemented at the gain-phase adjuster circuit (520). Next, the baseband processor measures the amount of transmits signal energy detected at the receiver (525). For example, the baseband processor detects transmitter interference by measuring the output of the demodulator. If the detected transmit signal energy is above a threshold, or otherwise not a minimum (530), a new gain and/or phase adjustment is implemented at the gain-phase adjuster circuit (520). Alternatively, if the detected transmit signal energy is a minimum, then the particular gain-phase adjustment is used until the next update, or calibration cycle. For example, the coefficients of the gain-phase adjuster circuit can be stored and used until a subsequent update.

As discussed above, there are other coupling paths through which unwanted transmit signal may couple into the receiver (e.g., α_{ANT}, α_{COMP}, α_{PCB}, α_{IC}). Typically, design choices can be made to reduce some of the coupling mechanisms, through such techniques as electromagnetic shielding. Thus, usually one of the coupling paths (i.e., α_{ANT}) is dominant, so that removal of it will result in satisfactory performance. Nevertheless, there may be instances in which the other coupling mechanisms are also significant.

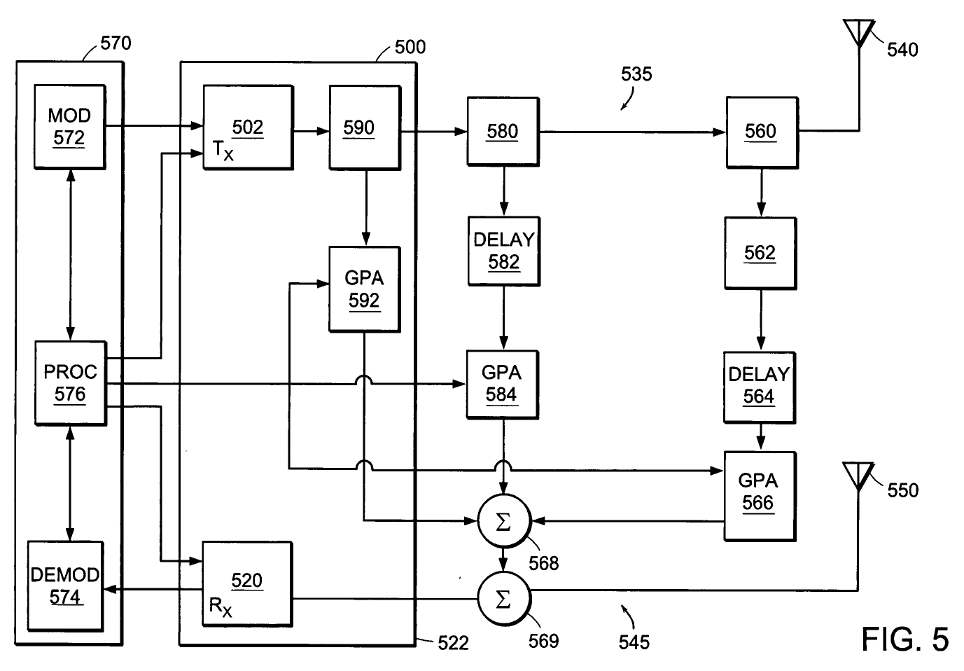

Fortunately, the interference cancellation technique describe above can similarly be applied to one or more of each of these different coupling paths for improved performance. Briefly, referring now to FIG. 5, a separate sampler can be installed at each location within the transmit chain at which the coupling is occurring. Thus, a first sampler 560 directed to the antenna-to-antenna coupling is coupled at the transmit antenna input, between the transmit antenna 540 and the transmit path 535. Similarly, a second sampler 580 directed to the component-to-component coupling is coupled at the transceiver's RF output 512, between the transceiver 500 and the transmit path 535. Additionally, a third sampler 590, directed to the board or module level coupling is coupled at the output of the transmitter 502.

As described above, each of the samplers 560, 580, 590 is coupled to a respective gain-phase adjuster circuits 566, 584, 592. Each of the gain-phase adjuster circuit 566, 584, 592, in turn, receives a respective control input from a baseband processor 576, the respective control input adjusts the gain and/or phase of the respective gain-phase adjuster circuits 566, 584, 592 as described above. Similarly, the first sampler can optionally include a receive path simulator 564 and/or a delay device 562. Further, the second sampler can include a second delay device 582, however a receive path simulator is not necessary as the second coupling path occurs on the receiver side of the receive path. Each of the gain-phase adjusted output signals is combined with the intended signal.

In one embodiment, the interference canceller includes two combiners 568, 569. The first combiner 568 combines the gain-phase adjusted signals from each of the multiple gain-phase adjuster circuits 566, 584, 592 forming a composite gain-phase adjusted signal. The second combiner 569 then combines the composite gain-phase adjusted signal with the intended received signal, resulting in a multiply compensated signal input to the receiver 520.

While this invention has been particularly shown and described with references to preferred embodiments thereof, it will be understood by those skilled in the art that various changes in form and details may be made therein without departing from the scope of the invention encompassed by the appended claims.

What is claimed is:

1. A wireless network transceiver system comprising:
an RF transceiver including an RF transmit path and an RF receive path;
a sampler obtaining a sample of a transmit signal from the RF transmit path;
a gain-phase gain-phase adjuster circuit that adjusts the transmit signal sample from the sampler and supplies the adjusted transmit signal sample to the RF receive path;
a gain-phase controller adjusting the gain-phase adjuster circuit to minimize at a calibration frequency effects of the transmit signal cross-coupling to the RF receive path.

2. The system of claim 1, wherein the calibration frequency is selectable.

3. The system of claim 1, wherein the gain-phase adjuster circuit comprises a controllable phase shifter receiving the transmit signal sample, the phase shifter shifting the phase of the transmit signal sample in response to adjusting the gain-phase adjuster circuit.

4. The system of claim 3, wherein the controllable phase shifter comprises:
a poly-phase filter generating in response to receiving the transmit signal sample a pair of signals having relative phases that are substantially orthogonal with respect to each other; and
a controllable vector modulator coupled to the poly-phase filter receiving the pair of signals, and adjusting the amplitude of at least one of the pair of signals in response to adjusting the gain-phase adjuster circuit, wherein the adjusted pair of signals are recombined yielding a phase-adjusted signal.

5. The system of claim 4, further comprising a balun transformer coupled to the poly-phase filter, the balun transformer converting a single-ended transmit signal sample into a differential transmit signal sample.

6. The system of claim 3, wherein the gain-phase adjuster circuit comprises a controllable amplitude adjuster coupled to the controllable phase shifter, the amplitude adjuster adjusting the amplitude of the transmit signal sample in response to adjusting the gain-phase adjusting circuit.

7. The system of claim 6, wherein the controllable amplitude adjusting device comprises a variable attenuator varying the amplitude of the phase-adjusted signal in response to adjusting the gain-phase adjuster circuit.

8. The system of claim 6, wherein the controllable amplitude adjusting device comprises a variable gain amplifier, varying the amplitude of the transmit signal sample in response to the adjusting of the gain-phase adjusting circuit.

9. The system of claim 1, further including a receiver path simulator coupled between the sampler and the gain-phase adjuster, wherein the receiver path simulator simulates the receive path.

10. The system of claim 1, further including a delay device coupled between the sampler and the gain-phase adjuster circuit, the delay device adding a delay to the transmit signal sample.

11. The system of claim 10, wherein the delay device comprises a transmission line.

12. The system of claim 1, wherein the gain-phase controller is a baseband controller adjusting the gain-phase adjuster in response to receiving a baseband representation of the received signal.

13. The system of claim 12, wherein the baseband controller is a digital baseband controller.

14. The system of claim 12, wherein the baseband controller resides on a chip.

15. The system of claim 1, further comprising:
a second sampler obtaining a different sample of the transmit signal; and
a second gain-phase adjusting circuit that samples the transmit signal sample to further adjust the gain-phase adjusting circuit to further minimize effects of the transmit signal cross-coupling to the RF receive path.

16. The system of claim 1, wherein the sampler comprises a directional coupler.

17. The system of claim 1, wherein the gain-phase adjuster circuit includes a high impedance output for coupling to the RF receive path.

18. A method for canceling receiver interference within a transceiver having a transmitter coupled to a transmit antenna through transmit path and a receiver coupled to a receive antenna through receive path, the interference resulting from coupling of a local transmit signal at the receiver, the method comprising:
calibrating gain and phase offsets;
receiving an intended signal;
coupling a sample of a transmit signal having an amplitude and a phase;
adjusting the gain of the sampled transmit using the gain offset;
adjusting the phase of the transmit signal sample using the phase offset; and
combining the gain-phase adjusted transmit signal sample with the received intended signal.

19. The method of claim 18, wherein calibrating gain and phase offsets comprises:
transmitting from the transceiver a known signal;
tuning the transceiver to a selected receive frequency;
measuring the receiver's baseband output; and
adjusting the gain and phase offsets in response to the measured receiver's baseband output.

20. The method of claim 19, wherein the transmitted known signal is a narrowband signal.

21. The method of claim 19, wherein the transmitted known signal is a broadband signal.

22. The method of claim 21, wherein the broadband signal is an 802.11 signal.

23. The method of claim 19, wherein the selected receive frequency is an average frequency.

24. The method of claim 18, wherein adjusting the phase comprises:
generating a pair of signals having relative phases that are substantially orthogonal with respect to each other;
adjusting the amplitude of at least one of the pair of signals in response to adjusting the gain-phase adjuster circuit; and
combining the adjusted pair of signals.

25. The method of claim 18, wherein the controllable amplitude adjusting device comprises a variable attenuator varying the amplitude of the phase-adjusted signal in response to adjusting the gain-phase adjuster circuit.

26. The method of claim 18, wherein adjusting the gain comprises varying the amplitude of the phase-adjusted signal in response to adjusting the gain-phase adjuster circuit.

27. The method of claim 18, further comprising converting a single-ended transmit signal sample into a differential transmit signal sample.

28. The method of claim 18, further comprising adding a delay to the transmit signal sample.

29. The method of claim 18, wherein generating a control input comprises receiving a baseband representation of the received signal.

30. The method of claim 18, further comprising:
coupling a second sample of a transmit signal having an amplitude and a phase;
adjusting the gain of the second transmit signal sample in response to adjusting the gain-phase adjuster circuit;
adjusting the phase of the second transmit signal sample in response to adjusting the gain-phase adjuster circuit; and
combining the gain-phase adjusted second transmit signal sample with the received intended signal.

31. An interference cancellation system for reducing interference at a local receiver by reducing unintentional coupling of a local transmit signal to the local receiver, the system comprising:
a controller generating a control input;
a first sampler sampling a transmit signal having an amplitude and a phase;
a gain-phase adjusting circuit coupled to the controller and the sampler, the gain-phase adjusting circuit receiving the transmit signal sample and adjusting the gain-phase adjuster circuit, and further adjusting the gain and phase of the transmit signal sample in response to adjusting the gain-phase adjuster circuit; and
a combiner coupled between the gain-phase adjuster and the receiver, the combiner receiving the gain-phase adjusted transmit signal sample and receiving an intended received signal, the combiner forming an adjusted received signal by combining the two received signals.

32. An interference cancellation system for reducing interference at a local receiver by reducing unintentional coupling of a local transmit signal to the local receiver, the system comprising:
means for calibrating gain and phase offsets;
means for receiving an intended signal;
means for coupling a sample of a transmit signal having an amplitude and a phase;
means for adjusting the gain of the sampled transmit using the gain offset;
means for adjusting the phase of the transmit signal sample using the phase offset; and
means for combining the gain-phase adjusted transmit signal sample with the received intended signal.
